(19) United States
(12) Patent Application Publication
(10) Pub. No.: US 2007/0052603 A1
(43) Pub. Date: Mar. 8, 2007

(54) Multiple loop RFID system

(76) Inventor: Shesh Nyalamadugu, Chula Vista, CA (US)

Correspondence Address: JAMES C WESEMAN;LAW OFFICES OF JAMES C WESEMAN, 401 WEST A STREET, SUITE 1600, SAN DIEGO, CA, 92101, US

(21) Appl. No.: 11/495,897

(22) Filed: Jul. 28, 2006

Related U.S. Application Data
(60) Provisional application No. 60/703,513, filed on Jul. 28, 2005.

(51) Int. Cl. H01Q 11/12

(52) U.S. Cl. 343/742; 340/572.7; 235/451

(57) ABSTRACT

An RFID system that provides an RFID tag comprising a plurality of RFID loop antennas operatively connected to an RFID chip.

### FIELD OF THE INVENTION

The present invention relates to the field of radio frequency identification (RFID) tagging and, more particularly, to an RFID system having a dual loop tag antenna which identifies medical equipment electrodes and gives the flexibility of electrode connector interchangeability.

### BACKGROUND OF THE INVENTION

Radio frequency identification (RFID) tags and labels (collectively referred to herein as “devices”) are widely used to associate an object with an identification code. RFID devices generally have a combination of antennas and analog and/or digital electronics, which may include for example communications electronics, data memory, and control logic. For example, RFID tags are used in conjunction with security-locks in cars, for access control to buildings, and for tracking inventory and parcels.

As noted above, RFID devices are generally categorized as labels or tags. RFID labels are RFID devices that have a surface attached directly to an object, adhesively or otherwise. RFID tags, in contrast, are secured to objects by other means, for example by use of a plastic fastener, string, embedding of implantation, or other securing means.

RFID devices generally utilize an antenna structure that is operatively coupled to electrical or electronic components, in the form of a chip or a strap (such as is described in U.S. Pat. No. 6,606,247), to communicate with a receiver or transceiver device such as a detector or reader. The antenna structure utilizes conductive material arranged on a dielectric substrate in a suitable array. The antenna structure is coupled to the chip or strap to allow communication between the RFID device and the reader and the detector. A wide variety of antenna sizes, shapes, and configurations may be utilized to achieve various communication characteristics, depending on many factors.

The conductive material of the antenna structure may be attached on the dielectric substrate by any of a variety of suitable methods. One such method involves printing of a conductive ink to form the antenna structure. Such conductive inks may include any of a variety of suitable electrically conductive materials, including conductive metal particles, carbon particles, or conductive polymer particles.

RFID tagging is an emerging technology used for identifying, authenticating and tracking objects. RFID has become widely used in virtually every industry, including transportation, manufacturing, asset tracking, airline baggage tracking, and highway toll management. As opposed to more traditional technologies involving printed barcodes and line-of-sight scanning devices, the RF identification process involves the transmission and reception of radio waves between the tag, which contains the transponder, and the base station. The transponder comprises a semi-conductor chip comprised of RF circuits, logic and memory, and an antenna, which allows reception and transmission of radio waves by radiating or absorbing energy in a variety of bandwidths.

### DISCLOSURE OF THE INVENTION

The present invention meets the above needs by providing an RFID system which utilizes a multiple loop antenna RFID tag. In one aspect, the present invention provides an RFID tag comprising a plurality of RFID loop antennas operatively connected to an RFID chip.

In another aspect of the invention, an RFID system is provided comprising at least one connector cable, wherein at least one of said connector cables having a plurality of antenna connectors. At least two of the antenna connectors will each have an RFID antenna attached thereto, and an RFID reader will be utilized having a power rating sufficient such that there is no substantial interference between the RFID antennas when the reader is activated. The system will also include at least one RFID tag comprising a plurality of RFID loop antennas operatively connected to an RFID chip.

### BRIEF DESCRIPTION OF DRAWINGS

FIG. 1 is a diagrammatic view of an embodiment of a cabling system with reader antennas attached to it, wherein 1A-1D are each a connector with a reader loop antenna connected to it;

FIG. 2 is a diagrammatic view of a sample electrode, wherein 2A and 2B are two connector pins wherein electrode connectors are connected to these pins and an RFID tag is attached to this electrode, which is read by a reader antenna;

FIG. 3 is diagrammatic view of a sample electrode with a circular loop tag attached to it, wherein 3A is an RFID tag attached to this electrode;

FIG. 4 is diagrammatic view of a dual loop RFID tag, wherein 4A and 4B are two loops and 4C is an RF chip, wherein the tag is attached in such away that each pin on the electrode remains in the center of each loop; and

FIG. 5 is diagrammatic view of an electrode with a dual loop RFID tag attached to it, wherein 5A and 5B are two loops, and the tag is attached in such away that each pin on the electrode remains in the center of each loop.

### DETAILED DESCRIPTION OF THE INVENTION

The present invention meets the above needs by providing an RFID system which utilizes a multiple loop antenna RFID tag. In one aspect, the present invention provides an RFID tag comprising a plurality of RFID loop antennas operatively connected to an RFID chip.

In another aspect of the invention, an RFID system is provided comprising at least one connector cable, wherein at least one of said connector cables having a plurality of antenna connectors. At least two of the antenna connectors will each have an RFID antenna attached thereto, and an RFID reader will be utilized having a power rating sufficient such that there is no substantial interference between the RFID antennas when the reader is activated. The system will also include at least one RFID tag comprising a plurality of RFID loop antennas operatively connected to an RFID chip.

Certain types of medical equipment, such as impedance cardiogram (ICG) and electrocardiogram (ECG) devices, use electrodes that are attached to patients to take hemodynamic measurements in the body. These electrodes are connected to a monitoring system through cables. Disposable electrodes are attached to the body to make these measurements. In order to identify particular type of electrodes and to prevent recurring usage of electrodes, RFID technology can be used. RFID tags are placed on the electrodes to transmit identification information and to monitor their use.

Components of the Present System

In order to implement the present system, certain aspects of RFID antennas, RFID tags, electrode connectors and RFID readers constructed in accordance with the prior art may be utilized.

For example, RFID antennas can be constructed according to any means now known or developed in the future. In the typical RFID antenna, a non-conductive substrate can include any of a variety of suitable materials, such as a suitable polymeric material. Examples of suitable such materials include, but are not limited to, high Tg polycarbonate, poly(ethylene terephthalate), polyarylate, polysulfone, a norbornene copolymer, poly phenylsulfone, polyetherimide, polyethylenenaphthalate (PEN), polyethersulfone (PES), polycarbonate (PC), a phenolic resin, polyester, polyimide, polyetherester, polyetheramide, cellulose acetate, aliphatic polyurethanes, polyacrylonitrile, polytrifluoroethylenes, polyvinylidene fluorides, HDPEs, poly(methyl methacrylates), a cyclic or acyclic polyolefin, or paper, among others.

Conductive material used in the fabrication of the antenna can include any suitable conductive materials, such as suitable conductive inks. Such conductive inks may include inks with suitable conductive materials such as conductive metal or non-metal particles. Examples of suitable conductive materials include copper particles, nickel particles, silver particles, aluminum particles, various metal alloy particles, carbon particles, and conductive polymer particles. Examples of conductive polymers include intrinsically conductive polymers such as polyethylenedioxythiophene (PEDOT), polypyrrole (PPy), or polyaniline (PANI), among others.

Conductive inks may be selectively deposited to form the antenna structure by any of a variety of suitable processes, such as flexo printing, offset printing, and gravure printing. The resistance may be less than 100 ohms per square. (Resistivity is measured on a strip with a 10:1 length to width ratio. Ohm/square is determined by dividing the resistance measurement along the length by 10.) Of course, it will be appreciated that the choice of material may depend on such factors as cost and availability of conductive materials, and the level of conductivity required.

The antenna structure may also include conductive materials deposited in other ways, such as by electroplating, physical deposition, or chemical deposition. For example, a layer of copper may be deposited by such methods. Selective removal processes such as etching may be used to remove suitable portions of the deposited conductive material.

RFID transponders (also called labels or tags) are also utilized for tagging the electrodes. An RFID transponder generally comprises an RFID antenna and any of a variety of combinations of wireless communication devices (RFID chips) with conductive leads coupled thereto to facilitate electrical connection. Examples of suitable RFID chips include the Philips HSL chip, available from Philips Electronics, and the EM Marin EM4222, available from EM Microelectronic-Marin SA, as well as RFID chips available from Matrics Inc. of Columbia, Md. USA.

The RFID chip may be coupled to the antenna structure by any of a variety of suitable methods, such as, for example, by use of a conductive adhesive, by use of welding and/or soldering, or by electroplating.

It will be appreciated that the RFID device may have other layers and/or structures. For example, the RFID device may have an adhesive layer for use in adhering the RFID device to an object. The adhesive layer may have a peel layer thereupon for protecting the adhesive prior to use. The RFID device may also have other layers, such as protective layers, and/or a printable layer for printing information thereupon. It will be appreciated that the RFID device may also include additional suitable layers and/or structures, other than those mentioned herein.

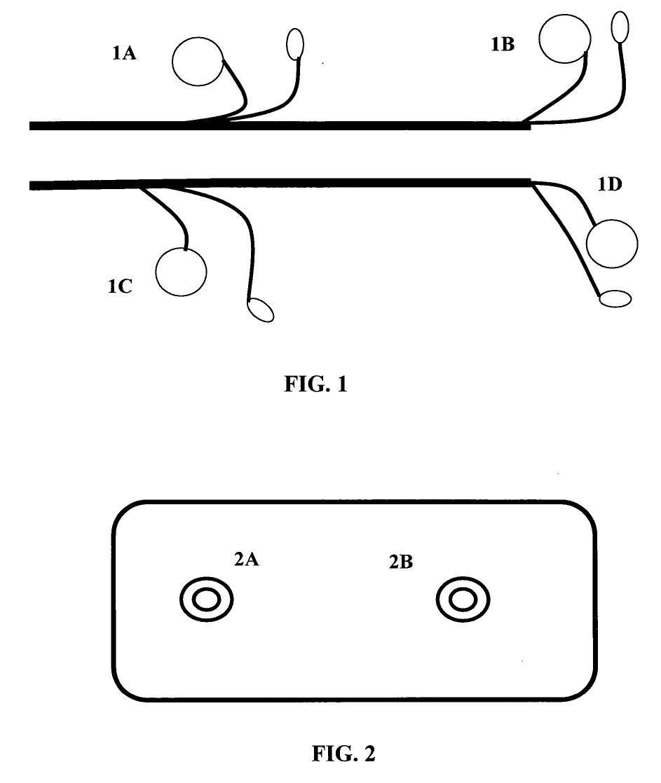

An RFID system with RFID reader antennas connected as shown in FIG. 1 can be used to identify medical electrodes. With such a system there is often a problem of not reading the identification information without the use of custom made tags, designed to improve the readability of the electrodes, and to provide the flexibility of interchanging the connectors.

The present invention provides a means of avoiding such problems by providing an RFID system including tags which can identify electrodes and afford the flexibility of the interchangeability of the connectors. For a typical application, there are four electrode connectors in each arm of the cable. Two antennas are connected to two of these electrode connectors and are connected to a single RFID reader. This RFID reader communicates with the tag by sending an RF signal through the antennas.

Each Electrode has two connector pins for attaching the connectors and two electrode connectors are connected to each electrode. An RFID tag can be attached to the electrode as shown in FIG. 2. With an RFID system where a reader antenna is connected to one of the two connectors of each electrode, when a connector is connected to the electrode it reads the information stored in the tag using the reader antennas connected to the electrode connecters.

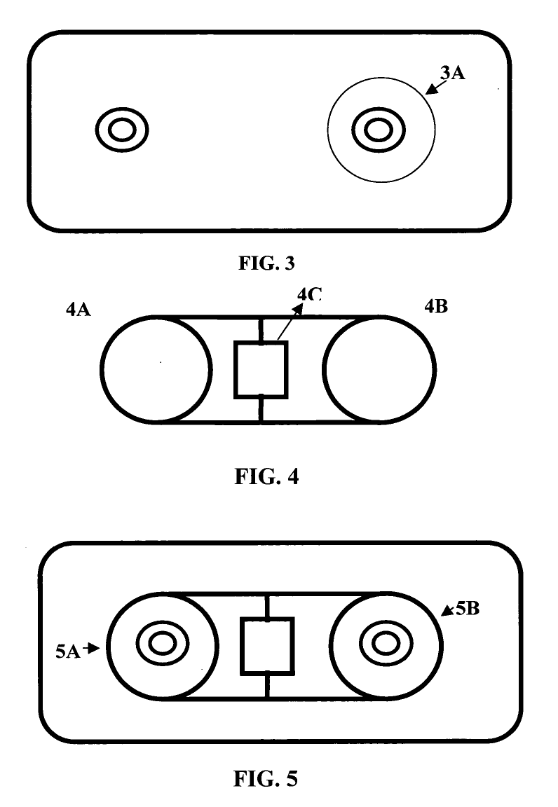

In typical applications like this, there is a problem of not reading the identification information when a connector without a reader antenna is connected to the pin with the RFID tag, as shown in FIG. 3. For a typical application where any connecter can be connected to any pin of the electrode, this problem is more critical, as it does not allow for interchangeability of the connectors.

As shown in FIGS. 4 and 5, a dual loop RFID tag can be used to solve this problem. In order to improve the system readability and to provide more flexibility of using the connectors, a dual loop tag can be used. A dual loop tag is an RF chip with two loop antennas operatively attached to it. This feature solves the problem of non-readability when a connecter without a reader antenna is connected to the electrode pin with an RFID tag attached to it. A single tuning and matching circuit can be used to tune and match the two loops. In operation tags with dual loop antennas are placed on the electrode as shown in FIG. 5 so that even if the connectors are interchanged the reader antenna can read the correct information from the tag.

All patents and patent applications cited in this specification are hereby incorporated by reference as if they had been specifically and individually indicated to be incorporated by reference.

Although the foregoing invention has been described in some detail by way of illustration and Example for purposes of clarity and understanding, it will be apparent to those of ordinary skill in the art in light of the disclosure that certain changes and modifications may be made thereto without departing from the spirit or scope of the appended claims.

1. An RFID tag comprising a plurality of RFID loop antennas operatively connected to an RFID chip.

2. An RFID system comprising:
(a) at least one connector cable, wherein at least one of said connector cables having a plurality of antenna connectors;
(b) at least two of said antenna connectors each having an RFID antenna attached thereto;
(c) an RFID reader having a power rating sufficient such that there is no substantial interference between said at least two RFID antennas when said reader is activated; and
(d) at least one RFID tag comprising a plurality of RFID loop antennas operatively connected to an RFID chip.

3. An RFID system as recited in claim 2 further comprising a plurality of electrodes at least two of which having an RFID tag thereon and capable of being detected by said RFID reader without substantial interference therebetween.

4. An RFID system as recited in claim 2 wherein said RFID reader comprising individual tuning and matching networks for the plurality of antennas attached to the reader.
